(19) United States
(12) Patent Application Publication
(10) Pub. No.: US 2025/0061129 A1
(43) Pub. Date: Feb. 20, 2025

(54) SYSTEM AND METHOD FOR INFERRED LINEAGE IN DATA TRANSFORMATION

(71) Applicant: Securiti, Inc., San Jose, CA (US)

(72) Inventors: Michael Rinehart, Pleasanton, CA (US); Michael Busha, Menlo Park, CA (US); Xiaolin Wang, San Jose, CA (US); Venkata Sunil Yarram, San Ramon, CA (US)

(21) Appl. No.: 18/792,889

(22) Filed: Aug. 2, 2024

Related U.S. Application Data
(60) Provisional application No. 63/519,824, filed on Aug. 15, 2023.

(51) Int. Cl. G06F 16/25

(52) U.S. Cl. CPC G06F 16/258

(57) ABSTRACT

A computer-implemented system for inferred lineage in data transformations is disclosed. A transformation module of the system includes a variation generation module to generate a plurality of variants by applying transformations to f source tables and corresponding target tables, a comparison module computes a table similarity and an inverse document frequency term, a sorting module to sort the columns of the source table, revise a plurality of estimates, and prune the column of the source table for a low revised estimates of coverage. A similar descriptors transformation module calculates a histogram-based similarity of two columns and variants, maps entries of the columns, calculate a score between the two histograms, and compute an artificial intelligence embedding. A mutual information module builds a supervised regression model, ranks importance of each feature, iteratively remove one feature, and stops the iterative removal of the feature at an occurrence of a jump in loss value.

### EARLIEST PRIORITY DATE

This application claims priority from a Provisional patent application filed in the United States of America having Patent Application No. 63/519,824, filed on Aug. 15, 2023, and titled “INFERRED LINEAGE UNDER DATA TRANSFORMATIONS”.

### FIELD OF INVENTION

Embodiments of a present disclosure relate to electronic text processing and more particularly a system and method for inferred lineage in data transformation.

### BACKGROUND

Inferred lineage refers to the process of deducing or inferring the lineage or history of data based on available information, such as metadata, transformation logic, data relationships, and the like. The inferred lineage is determined through analysis and inference. A data lineage is crucial for ensuring data quality, traceability, and regulatory compliance in industries such as finance, healthcare, government, and the like. In many organizations the data lineage understands from where the data comes and how the data is transformed, and where it's used, which is essential for data governance, auditing, and troubleshooting.

The current systems face challenges of protection of sensitive data, personal or otherwise. Sensitive data can proliferate, and it is critical to determine if it has been undesirably replicated and it is important to document how data is processed from source to target. The current systems faces challenges for 1 to 1, 1-to-many, many-to-1, and many-to-many relationships in taking columns from source tables to form destination tables, in stacking columns from source columns to form destination columns. Also, the current systems have limitations in data transformations on single columns, such as column merging, column splitting, data normalization, data truncation, data cleanup, data filtering and the like. Further, the existing systems have limitations for data transformations on multiple columns, including complex mathematical or Boolean logic conditional transformations, and the like. The data when transformed through a system may not be aligned, particularly samples from one table do not completely overlap with another. Also, the data transformed using the current system is unordered data. Further, columns that are very common such as yes/no columns which can lead to a false-positive inferred relationships. In some cases, the current systems during the data transformation, transforms data from external or untracked sources which is not a secure data transformation.

Hence, there is a need for a system for inferred lineage in data transformation and method thereof that addresses the aforementioned issues.

### OBJECTIVE OF THE INVENTION

An objective of the present invention is to provide a system and a method for inferred lineage in data transformation to determine which source table led to which target table.

Another objective of the present invention is to remove characters/text from a cell according to a user-supplied regular expression for avoiding repetitive text or spaces.

Yet, another objective of the present invention is to remove all whitespace from a cell.

Further, an objective of the present invention is to effectively mix of a data across tables so that the data transformed is in ordered manner.

### BRIEF DESCRIPTION

In accordance with an embodiment of the present disclosure, a computer-implemented system for inferred lineage in data transformations is provided. The computer-implemented system includes a hardware processor and a memory. The memory is operatively coupled to the hardware processor. The memory includes a set of instructions in the form of a processing subsystem, configured to be executed by the hardware processor. The processing subsystem is hosted on a server and configured to execute on a network to control bidirectional communications among a plurality of modules. The plurality of modules includes a transformation module, similar descriptors transformation module, and mutual information module. The transformation module includes a variation generation module, a comparison module, and a sorting module. The variation generation module is configured to generate a plurality of variants by applying a plurality of transformations to each column of a plurality of source tables and corresponding target tables. The comparison module is operatively coupled with the variation generation module. The comparison module is configured to use one or more column-similarity functions to compute a table similarity and compute an inverse document frequency term in a distributed manner. The comparison module is also configured to compute a term frequency in a distributed manner to determine a table lineage from a plurality of similarity scores. Further, the comparison module is configured to compute a sparse pairwise similarity matrix for each factor of a plurality of factors of a column by formulating the term frequency and the inverse document frequency term. Furthermore, the comparison module is configured to compute the sparse pairwise similarity matrix for each factor and a weighted sum of computed sparse pairwise similarity metrics to obtain a final sparse pairwise similarity matrix. The sorting module is operatively coupled with the comparison module. The sorting module is configured to sort the columns of the source table in descending order based on entries covered in a destination table and based on a column of the source table. The sorting module is also configured to revise a plurality of estimates covered by the destination table. The revision is based on collection of tables to provide more weight to columns of source table based on destination table. Further, the sorting module is configured to prune the column of the source table for a low revised estimates of coverage and remove remaining corresponding column lineages to maintain similarities among the columns that have a table lineage. The similar descriptors transformation is module operatively coupled with the transformation module. The similar descriptors transformation module is configured to calculate a histogram-based similarity of two columns and variants of columns if the column is non-numeric type. The similar descriptors transformation module is also configured to map a plurality of entries of the columns to count integers by sorting relative frequency and build a histogram for each column. Further, the similar descriptors transformation module is configured to calculate a score between the two histograms using a Jensen Shannon divergence method. Furthermore, the similar descriptors transformation module is configured to compute an artificial intelligence embedding by calculating an embedding for each column, variants of columns, and computing similarities among the variants of columns by using a number of metrics. The mutual information module is operatively coupled with the similar descriptors transformation module. The mutual information module is configured to build a supervised regression model to be fitted with a numerical source column as an input data and a numerical target column and record a loss value rank importance of each feature corresponding to each numerical source column based on the score after fitting the supervised regression model. The mutual information module is also configured to iteratively remove one feature from the numerical source columns and re-fit the supervised regression model with new numerical source columns and the numerical target column by removing one feature and record a loss value. Further, the mutual information module is configured to stop the iterative removal of the feature at an occurrence a jump in loss value and generate a target column by using remaining features as top source columns. The remaining features are the features remained after stopping the iterative removal of the feature.

In accordance with an embodiment of the present disclosure, a method for operating computer-implemented system for inferred lineage in data transformation is provided. The method includes generating, by variation generation module of a transformation module of a processing subsystem, a plurality of variants by applying a plurality of transformations to each column of a plurality of source tables and corresponding target tables. The method also includes using, by a comparison module of the transformation module of a processing subsystem, one or more column-similarity functions to compute a table similarity and compute an inverse document frequency term in a distributed manner. Further, the method includes computing, by the comparison module of the transformation module of a processing subsystem, a term frequency in a distributed manner to determine a table lineage from a plurality of similarity scores. Furthermore, the method includes computing, by the comparison module of the transformation module of a processing subsystem, a sparse pairwise similarity matrix for each factor of a plurality of factors of a column by formulating the term frequency and the inverse document frequency term. Moreover, the method includes computing, by the comparison module of the transformation module of a processing subsystem, the sparse pairwise similarity matrix for each factor and a weighted sum of computed sparse pairwise similarity metrics to obtain a final sparse pairwise similarity matrix. Moreover, the method includes sorting, by a sorting module of the transformation module of the processing subsystem, columns of the source table in descending order based on entries covered in a destination table and based on a column of the source table. Moreover, the method includes revising, by the sorting module of the transformation module of the processing subsystem, a plurality of estimates covered by the destination table, wherein the revision is based on collection of tables to provide more weight to columns of source table based on destination table. Moreover, the method includes pruning, by the sorting module of the transformation module of the processing subsystem, the column of the source table for a low revised estimates of coverage and remove remaining corresponding column lineages to maintain similarities among the columns that have a table lineage. Moreover, the method includes calculating, by a similar descriptors transformation module of the processing subsystem, a histogram-based similarity of two columns and variants of columns if the column is non-numeric type. Moreover, the method includes mapping, by the similar descriptors transformation module of the processing subsystem, a plurality of entries of the columns to count integers by sorting relative frequency and build a histogram for each column. Moreover, the method includes calculating, by the similar descriptors transformation module of the processing subsystem, a score between the two histograms using a Jensen Shannon divergence method. Moreover, the method includes computing, by the similar descriptors transformation module of the processing subsystem, an artificial intelligence embedding by calculating an embedding for each column, variants of columns, and computing similarities among the variants of columns by using a number of metrics. Moreover, the method includes building, by a mutual information module of the processing subsystem, a supervised regression model to be fitted with a numerical source column as an input data and a numerical target column and record a loss value. Moreover, the method includes ranking, by the mutual information module of the processing subsystem, importance of each feature corresponding to each numerical source column based on the score after fitting the supervised regression model. Moreover, the method includes iteratively removing, by the mutual information module of the processing subsystem, one feature from the numerical source columns and re-fit the supervised regression model with new numerical source columns and the numerical target column by removing one feature and record a loss value. Moreover, the method includes stopping, by the mutual information module of the processing subsystem, the iterative removal of the feature at an occurrence a jump in loss value and generate a target column by using remaining features as top source columns, wherein the remaining features are the features remained after stopping the iterative removal of the feature.

In accordance with an embodiment of the present disclosure, a non-transitory computer-readable medium storing a computer program that, when executed by a processor, causes the processor to perform a method for operating computer-implemented system for inferred lineage is provided. The method includes generating, by variation generation module of a transformation module of a processing subsystem, a plurality of variants by applying a plurality of transformations to each column of a plurality of source tables and corresponding target tables. The method also includes using, by a comparison module of the transformation module of a processing subsystem, one or more column-similarity functions to compute a table similarity and compute an inverse document frequency term in a distributed manner. Further, the method includes computing, by the comparison module of the transformation module of a processing subsystem, a term frequency in a distributed manner to determine a table lineage from a plurality of similarity scores. Furthermore, the method includes computing, by the comparison module of the transformation module of a processing subsystem, a sparse pairwise similarity matrix for each factor of a plurality of factors of a column by formulating the term frequency and the inverse document frequency term. Moreover, the method includes computing, by the comparison module of the transformation module of a processing subsystem, the sparse pairwise similarity matrix for each factor and a weighted sum of computed sparse pairwise similarity metrics to obtain a final sparse pairwise similarity matrix. Moreover, the method includes sorting, by a sorting module of the transformation module of the processing subsystem, columns of the source table in descending order based on entries covered in a destination table and based on a column of the source table. Moreover, the method includes revising, by the sorting module of the transformation module of the processing subsystem, a plurality of estimates covered by the destination table, wherein the revision is based on collection of tables to provide more weight to columns of source table based on destination table. Moreover, the method includes pruning, by the sorting module of the transformation module of the processing subsystem, the column of the source table for a low revised estimates of coverage and remove remaining corresponding column lineages to maintain similarities among the columns that have a table lineage. Moreover, the method includes calculating, by a similar descriptors transformation module of the processing subsystem, a histogram-based similarity of two columns and variants of columns if the column is non-numeric type. Moreover, the method includes mapping, by the similar descriptors transformation module of the processing subsystem, a plurality of entries of the columns to count integers by sorting relative frequency and build a histogram for each column. Moreover, the method includes calculating, by the similar descriptors transformation module of the processing subsystem, a score between the two histograms using a Jensen Shannon divergence method. Moreover, the method includes computing, by the similar descriptors transformation module of the processing subsystem, an artificial intelligence embedding by calculating an embedding for each column, variants of columns, and computing similarities among the variants of columns by using a number of metrics. Moreover, the method includes building, by a mutual information module of the processing subsystem, a supervised regression model to be fitted with a numerical source column as an input data and a numerical target column and record a loss value. Moreover, the method includes ranking, by the mutual information module of the processing subsystem, importance of each feature corresponding to each numerical source column based on the score after fitting the supervised regression model. Moreover, the method includes iteratively removing, by the mutual information module of the processing subsystem, one feature from the numerical source columns and re-fit the supervised regression model with new numerical source columns and the numerical target column by removing one feature and record a loss value. Moreover, the method includes stopping, by the mutual information module of the processing subsystem, the iterative removal of the feature at an occurrence a jump in loss value and generate a target column by using remaining features as top source columns, wherein the remaining features are the features remained after stopping the iterative removal of the feature.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for inferred lineage in data transformation in accordance with an embodiment of the present disclosure;

FIG. 2 is a block diagram representing collections of tables and their underlying relationships of FIG. 1 in accordance with an embodiment of the present disclosure;

FIG. 3 is a schematic representation of an exemplary embodiment of the replicated data under transformation of FIG. 1 in accordance with an embodiment of the present disclosure;

FIG. 4 is an exemplary embodiment of the representation of a pipeline structure for inferred lineage and detection of data replication of FIG. 1 in accordance with an embodiment of the present disclosure;

FIG. 5 is an exemplary embodiment of the representation of data transformation of FIG. 1 in accordance with an embodiment of the present disclosure;

FIG. 6 is a block diagram of a computer or a server in accordance with an embodiment of the present disclosure;

FIG. 7 (a) illustrates a flow chart representing the steps involved in a method for operating the system for inferred lineage in accordance with an embodiment of the present disclosure; and

FIG. 7 (b) illustrates the continued steps of involving in the method for operating the system for inferred lineage of FIG. 7 (a) in accordance with an embodiment of the present disclosure.

Further, those skilled in the art will appreciate that elements in the figures are illustrated or simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a computer-implemented system for inferred lineage in data transformations is provided. The computer-implemented system has a hardware processor and a memory. The memory is operatively coupled to the hardware processor. The memory includes a set of instructions in the form of a processing subsystem, configured to be executed by the hardware processor. The processing subsystem is hosted on a server and configured to execute on a network to control bidirectional communications among a plurality of modules. The plurality of modules includes a transformation module, similar descriptors transformation module, and mutual information module. The transformation module includes a variation generation module, a comparison module, and a sorting module. The variation generation module is configured to generate a plurality of variants by applying a plurality of transformations to each column of a plurality of source tables and corresponding target tables. The comparison module is operatively coupled with the variation generation module. The comparison module is configured to use one or more column-similarity functions to compute a table similarity and compute an inverse document frequency term in a distributed manner. The comparison module is also configured to compute a term frequency in a distributed manner to determine a table lineage from a plurality of similarity scores. Further, the comparison module is configured to compute a sparse pairwise similarity matrix for each factor of a plurality of factors of a column by formulating the term frequency and the inverse document frequency term. Furthermore, the comparison module is configured to compute the sparse pairwise similarity matrix for each factor and a weighted sum of computed sparse pairwise similarity metrics to obtain a final sparse pairwise similarity matrix. The sorting module is operatively coupled with the comparison module. The sorting module is configured to sort the columns of the source table in descending order based on entries covered in a destination table and based on a column of the source table. The sorting module is also configured to revise a plurality of estimates covered by the destination table. The revision is based on collection of tables to provide more weight to columns of source table based on destination table. Further, the sorting module is configured to prune the column of the source table for a low revised estimates of coverage and remove remaining corresponding column lineages to maintain similarities among the columns that have a table lineage. The similar descriptors transformation is module operatively coupled with the transformation module. The similar descriptors transformation module is configured to calculate a histogram-based similarity of two columns and variants of columns if the column is non-numeric type. The similar descriptors transformation module is also configured to map a plurality of entries of the columns to count integers by sorting relative frequency and build a histogram for each column. Further, the similar descriptors transformation module is configured to calculate a score between the two histograms using a Jensen Shannon divergence method. Furthermore, the similar descriptors transformation module is configured to compute an artificial intelligence embedding by calculating an embedding for each column, variants of columns, and computing similarities among the variants of columns by using a number of metrics. The mutual information module is operatively coupled with the similar descriptors transformation module. The mutual information module is configured to build a supervised regression model to be fitted with a numerical source column as an input data and a numerical target column and record a loss value rank importance of each feature corresponding to each numerical source column based on the score after fitting the supervised regression model. The mutual information module is also configured to iteratively remove one feature from the numerical source columns and re-fit the supervised regression model with new numerical source columns and the numerical target column by removing one feature and record a loss value. Further, the mutual information module is configured to stop the iterative removal of the feature at an occurrence a jump in loss value and generate a target column by using remaining features as top source columns. The remaining features are the features remained after stopping the iterative removal of the feature.

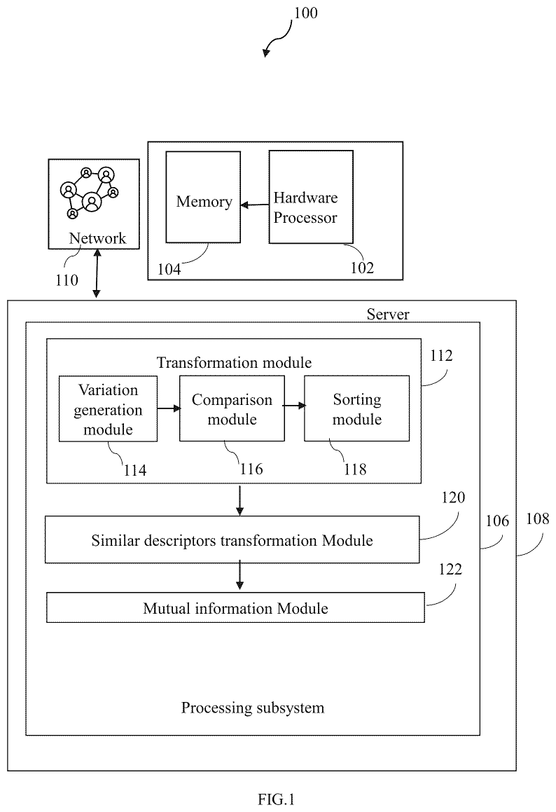

FIG. 1 is a block diagram representation of a computer-implemented system 100 for inferred lineage in data transformation in a file in accordance with an embodiment of the present disclosure. The computer-implemented system 100 includes a hardware processor 102. The computer-implemented system 100 also includes a memory 104. The memory 104 is operatively coupled to the hardware processor 102. The memory 104 includes a set of instructions in the form of a processing subsystem 106, configured to be executed by the hardware processor 102. The processing subsystem 106 is hosted on a server 108 and configured to execute on a network 110 to control bidirectional communications among a plurality of modules. In one embodiment, the network 110 may include one or more terrestrial and/or satellite networks interconnected to communicatively connect a user device to web server engine and a web crawler. In one example, the network 110 may be a private or public local area network (LAN) or wide area network, such as the Internet. In one embodiment, the inferred lineage in data transformation, refers to the process of automatically determining the relationships between different datasets or data elements as they undergo transformations. This lineage provides insights into how data is transformed throughout various stages of a data pipeline or workflow.

The plurality of modules includes a transformation module 112, a similar descriptors transformation module 120, and a mutual information module 122. The transformation module 112 includes a variation generation module 114, a comparison module 116, and a sorting module 118. In one embodiment, the transformation module 112 is configured to remove unlikely column lineage content.

The variation generation module 114 is configured to generate a plurality of variants by applying a plurality of transformations to each column of a plurality of source tables and corresponding target tables. In one embodiment, the variant refers to a specific version or variation of a dataset resulting from a transformation process. In one embodiment, the plurality of transformations includes at least one of a lowercase, no transformations, a regex remover for removing characters from a cell according to a user-supplied regular expression, a split and take, truncate, whitespace cleaner, condition to apply a transformation based on a condition, composite including a chain of the previous transformations in a sequence. In one embodiment, the split and take transformation includes splitting of text according to a user-supplied regular expression and taking a specific index from the split. In one embodiment, if a variant generator is un-specified no transformation is applied (NoOp).

The comparison module 116 is operatively coupled with the variation generation module 114. The comparison module 116 is configured to use one or more column-similarity functions to compute a table similarity and compute an inverse document frequency (IDF) term in a distributed manner. In one embodiment, the table similarity refers to the measurement of similarity between two or more tables or datasets. In one embodiment, the IDF is used to measure the importance of a word within one or more table. It is typically used in conjunction with a term frequency (TF), which measures how often a term appears in a single table. The computing of the IDF is performed in a distributed manner which refers to a computing paradigm where tasks or operations are carried out across multiple interconnected nodes or machines in a network.

The comparison module 116 is also configured to compute a term frequency in a distributed manner to determine a table lineage from a plurality of similarity scores. In one embodiment, the term frequency (TF) measures how often a term appears in a single table. In one embodiment, the similarity scores can be useful for identifying relationships between different tables based on their structure, content, or metadata. Further, the comparison module 116 is configured to compute a sparse pairwise similarity matrix for each factor of a plurality of factors of a column by formulating the term frequency and the inverse document frequency term. Furthermore, the comparison module 116 is configured to compute the sparse pairwise similarity matrix for each factor and a weighted sum of computed sparse pairwise similarity metrics to obtain a final sparse pairwise similarity matrix. In one embodiment, the sparse pairwise similarity matrix is a matrix that represents the similarity between pairs of objects or entities, where the similarity values are predominantly zero or very low.

In one embodiment, the comparison module 116 is configured to compute a min-hash similarity of each pair of column-variations subject to a lower bound based on similarity. In another embodiment, the comparison module is configured to aggregate the column-variation similarities to compute the column-level similarities. Yet, in one embodiment, the comparison module is configured to compute term frequency-inverse document frequency to obtain the table similarity.

The sorting module 118 is operatively coupled with the comparison module 116. The sorting module 118 is configured to sort the columns of the source table in descending order based on entries covered in a destination table and based on a column of the source table. The sorting module 118 is also configured to revise a plurality of estimates covered by the destination table. The revision is based on collection of tables to provide more weight to columns of source table based on destination table. Further, the sorting module 118 is configured to prune the column of the source table for a low revised estimates of coverage and remove remaining corresponding column lineages to maintain similarities among the columns that have a table lineage.

The similar descriptors transformation module 120 is operatively coupled with the transformation module 112. The similar descriptors transformation module 120 is configured to calculate a histogram-based similarity of two columns and variants of columns if the column is non-numeric type. The similar descriptors transformation module 120 is also configured to map a plurality of entries of the columns to count integers by sorting relative frequency and build a histogram for each column. Further, the similar descriptors transformation module 120 is configured to calculate a score between the two histograms using a Jensen Shannon divergence method. Furthermore, the similar descriptors transformation module 120 is configured to compute an artificial intelligence embedding by calculating an embedding for each column, variants of columns, and computing similarities among the variants of columns by using a number of metrics. In one embodiment, the plurality of metrics includes at least one of an Euclidean distance, a dot product, and a cosine similarity.

The mutual information module 122 is operatively coupled with the similar descriptors transformation module 120. The mutual information module 122 is configured to build a supervised regression model to be fitted with a numerical source column as an input data and a numerical target column and record a loss value. The similar descriptors transformation module 120 is also configured to rank importance of each feature corresponding to each numerical source column based on the score after fitting the supervised regression model. Further, the similar descriptors transformation module 120 is configured to iteratively remove one feature from the numerical source columns and re-fit the supervised regression model with new numerical source columns and the numerical target column by removing one feature and record a loss value. Furthermore, the similar descriptors transformation module 120 is configured to stop the iterative removal of the feature at an occurrence a jump in loss value and generate a target column by using remaining features as top source columns. The remaining features are the features remained after stopping the iterative removal of the feature.

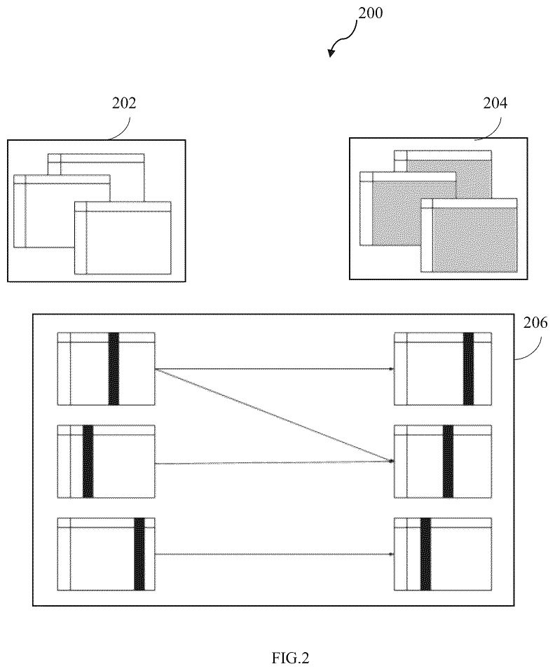

FIG. 2 is a block diagram representing collections of tables and their underlying relationships of FIG. 1 in accordance with an embodiment of the present disclosure. In one embodiment, a black column represents a column that is common among all tables. The black column represents an unlikely signal of lineage. In one embodiment, a plurality of source tables 202 and a plurality of target tables 204 are collected. In one embodiment, the data transformations are applied to all columns across all the source tables 202 and the target tables 204. The data transformation is not limited to a specific transformation, but it is possible to apply different transformations to all the source tables 202 and the target tables 204. In one embodiment, the relationship of a table with respect to one or more tables 206 is shown based on the black column of the respective table.

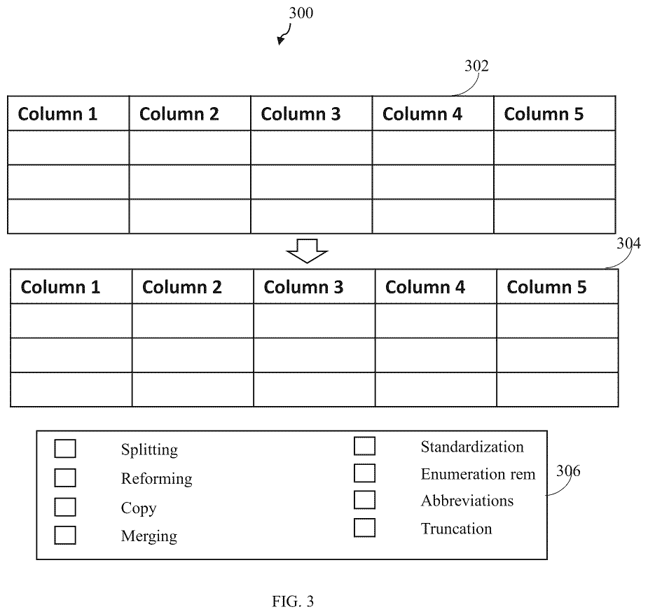

FIG. 3 is a schematic representation of an exemplary embodiment of the replicated data under transformation of FIG. 1 in accordance with an embodiment of the present disclosure. In one embodiment, the mutual information module 122 is configured to leverage mutual information to infer column lineage and it is applied to numerical columns. At a high level, for any numerical target column 2, all the numerical source columns is taken as input data X to build a regression model to infer the top source columns of the source table 302 that are used to generate output Y. Feature selection via a method such as stepwise, regularization, or otherwise can be used. A feature selection algorithm is applied by building a supervised regression model then fitting the model with X and Y and record the loss value. After recording the loss value, the importance of each feature is ranked corresponding to each numerical source column based on the importance score after fitting the model. After ranking, iteratively removal one feature from X starting from the least important feature is performed and re-fitting of the model with X and Y, and recording the loss value, stop when a jump in loss value is seen. The remaining features are then the top source columns that are used to generate the target column 2 of a target table 304.

In one embodiment, the plurality of transformations 306 includes but is not limited to no transformation (NoOp), lowercases cell text, a Regex Remover which removes characters and text from a cell according to a user-supplied regular expression, a split and take splits text according to a user-supplied regular expression and takes a specific index from that split, wherein an empty value is returned in the index exceeds the number of split parts. The data transformations also truncates a cell to a user-supplied number of characters, a white space cleaner removes all whitespace from a cell, a condition applied for any transformation based on the condition. For example, the condition may be a pluggable code. Further, the transformation includes composite chain any of the above transformations in a sequence.

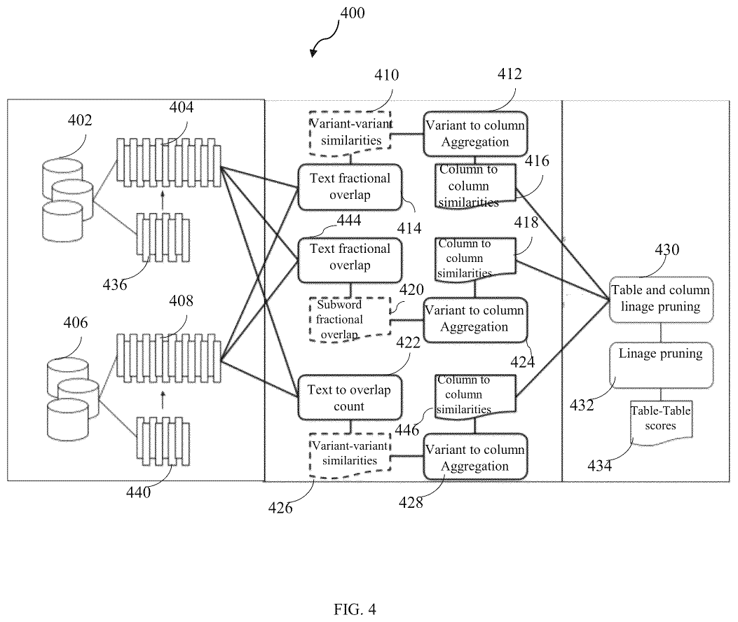

FIG. 4 is an exemplary embodiment of the representation of a pipeline structure for inferred lineage and detection of data replication of FIG. 1 in accordance with an embodiment of the present disclosure. Consider a non-limiting example of a consumer 406 produces a raw column 440 and a producer 402 produces a raw column 436 from which variants 408 and 404 are produced respectively. In one embodiment, for finding the column similarity consider,
V(c)=v{v₁, v₂, . . . } is the set of variations of column c from a table t,
sim (v, v′) is the similarity of two column variations v∈V(c) and v′∈V(c′) for some columns c and c′. For any two columns c and c′ from any two tables, we define the similarity the similarities are defined as:

$$sim ( c , {c}^{′} ) = {max}_{v ∈ V ( c )} {max}_{{v}^{′} ∈ V ( {c}^{′} )} sim ( v , {v}^{′} )$$

Other statistics over the set of variant similarities, such as the sum or average can be taken as well. There are a plurality of functions to be considered. The plurality of functions includes a variant-to-variant to variant similarity 410. The plurality of functions also includes a text fractional Overlap 414 which measures the fractional overlap 444 between two columns in terms of the unique values in each. Further, the plurality of functions also includes a subword fractional overlap 420 which measures the fractional overlap between two columns in terms of unique subwords in each. Furthermore, the plurality of functions also includes an intersection Cardinality or a text to overlap count 422 which measures the number of common elements between two columns in terms of the unique values in each. In general, any similarity function can be incorporated, including but not limited to the above three functions, a header similarity using, for example, embeddings or pairwise analysis.

In one embodiment, the non-limiting examples of similarity functions that can be used in the pipeline are:
fractional Overlap sim (v, v′)=J (v, v′) is the Jaccard similarity with each set element being from unique cell contents. This similarity function can be approximated using a subword fractional overlap 420. The subword fractional overlap uses sim (v, v′)=J (v, v′) which is the Jaccard similarity with each set element being from unique subwords in cells. In the intersection cardinality there are multiple options for this similarity function.

The first is sim (v, v′)=σ(|v∩v′|) is a squashing function σ: [symbol] →[0, 1] of the number of unique common elements between v and v′.

The second is

$$sim ( v , {v}^{′} ) = \frac{\vert v ⋂ {v}^{′} \vert}{min ( \vert v \vert , \vert {v}^{′} \vert ) + ϵ ,}$$

which measures the number of common elements normalized by the smaller set. The option of max is not considered here because that would yield Jaccard similarity. Either or both of these functions can be used, they can use cell and/or subword text.

In one embodiment, the system 100 performs variation generation and variant-similarity calculation. Every column in every table that is a producers table, and a consumers table is converted into a number of forms that are used for matching.

Consider V(c)={v₁, v₂, . . . } be the set of variations of column c from some table t,]
J (v, v′) be the Jaccard similarity of two column variations v∈V(c) and v′∈V(c′) for some columns c and c′. For any two columns c and c′ from any two tables, the similarity is defined under similarity method f as:

$${s}_{f} ( c , {c}^{′} ) = {max}_{v ∈ V ( c )} {max}_{v ∈ V ( {c}^{′} )} {s}_{f} ( v , {v}^{′} )$$

This calculation can be performed in Spark by computing the min-hash similarity of all pairs of column-variations subject to some lower bound L on the similarity and aggregating the column-variation similarities 426 to compute column-level similarities 428. The variant to column similarities are aggregated 412 to compute column-level similarities 416. Using a lower bound L to eliminate pairs that are highly dissimilar. Removing any variation v where J (v, v′)>L has too many matching pairs v′.

The column to column similarities are aggregated 418 to compute variant to column similarities 424. After finding column similarities 418, candidate table lineages are computed. Consider P be the set of parent tables, C be the set of child tables using one column-similarity 416 function to compute table similarity or table and column lineage pruning 430. For any lineage pruning 432, column similarity function s (c, c′)∈[0, 1], the similarity between two tables 434 is computed as:

$$tf ( c , t ) = tf ( c , t ) = {max}_{{c}^{′} ∈ t} ( c , {c}^{′} )$$

be the “term frequency” of a column to a table
n (c, T)=|{t∈T s. t. tf (c, t)>L}| be the number of tables in a set T of tables where column c has a tf score greater than L,
idf (c, T) be the “inverse document frequency (IDF)” of column c among the tables in the set T.

$$idf ( c , T ) = log \frac{\vert T \vert}{n ( c , T ) + 1} + 1$$

standard TF-IDF formulation |T|n (c, T)+l+l
idf other formulas i (c, T)= . . . .

In one embodiment, a producer table 406 tₚ and consumer table t_{c} 402 are truncated to their string columns, their p t c one-way similarity score function is:

$$s ( {t}_{p} , {t}_{c} ) = {\sum }_{c ∈ {t}_{p}} tf ( c , {t}_{c} ) \times idf ( c , C ) \geq 0$$

The one-way similarity is extended this to a two-way similarity score as:

$$\overline{s} ( {t}_{p} , {t}_{c} ) = agg ( s ( {t}_{p} , {t}_{c} ) , s ( {t}_{c} , {t}_{p} ) )$$

where agg ( ) may either be average ( ) or max ( ) This can be computed using a framework for computing a one-way scoring function by simply swapping the inputs. Column lineages would also need to be aggregated, and the same aggregation function can be considered. This calculation can be performed in Spark by following steps:
Computing column-to-column similarities 446.
Computing the inverse document frequency (IDF) term in a distributed fashion.
Computing the transfer function (TF) terms in a distributed fashion.
Computing TF-IDF to get the similarity.

Efficiency is achieved by:
Pruning pairwise calculations when computing column-level similarities that is attempting to limit each column to only a handful of matches.
Only computing scores among pairs of Producer and Consumer tables have some column similarity in common.

In one embodiment, the TF term may aggregate similarities using sum instead of max. Consider a several table similarity functions s_{data}, s_{header}, sₕᵢₛₜ and compute similarity score 434 from each via the following:

$${tf}_{i} ( c , t ) = {max}_{{c}^{′} ∈ t} {s}_{i} ( c , {c}^{′} ) \\ {n}_{i} ( c , T ) = \vert \{ t ∈ T s . t . {tf}_{i} ( c , t ) > 0 \} \vert \\ {idf}_{i} ( c , T ) = log \frac{\vert T \vert}{{n}_{i} ( c , T ) + 1} + 1 \\ s ( {t}_{p} , {t}_{c} ) = {\sum }_{c ∈ {t}_{p}} {\sum }_{i} {tf}_{i} ( c , {t}_{c} ) \times {idf}_{i} ( c , C ) \geq 0$$

which, for our specific similarity functions, translates into

$$s ( {t}_{p} , {t}_{c} ) = {\sum }_{c ∈ {t}_{p}} {tf}_{data} ( c , {t}_{c} ) \times {idf}_{data} ( c , C ) + {\sum }_{c ∈ {t}_{p}} {tf}_{header} ( c , {t}_{c} ) \times {idf}_{header} ( c , P ) + {\sum }_{c ∈ {t}_{p}} {tf}_{hist} ( c , {t}_{c} ) \times {idf}_{hist} ( c , C )$$

which is simply the sum of their individual table similarities:

$${s}_{data} ( {t}_{p} , {t}_{c} ) = {\sum }_{c ∈ {t}_{p}} {tf}_{data} ( c , {t}_{c} ) \times {idf}_{data} ( c , C ) \\ {s}_{header} ( {t}_{p} , {t}_{c} ) = {\sum }_{c ∈ {t}_{p}} {tf}_{header} ( c , {t}_{c} ) \times {idf}_{header} ( c , C ) \\ {s}_{hist} ( {t}_{p} , {t}_{c} ) = {\sum }_{c ∈ {t}_{p}} {tf}_{hist} ( c , {t}_{c} ) \times {idf}_{h Δ t} ( c , C ) \\ s ( {t}_{p} , {t}_{c} ) = {s}_{data} ( {t}_{p} , {t}_{c} ) + {s}_{header} ( {t}_{p} , {t}_{c} ) + {s}_{hist} ( {t}_{p} , {t}_{c} )$$

The individual scores may be weighted as well:

$$s ( {t}_{p} , {t}_{c} ) = {w}_{data} \times {s}_{data} ( {t}_{p} , {t}_{c} ) + {w}_{header} \times {s}_{header} ( {t}_{p} , {t}_{c} ) + {w}_{hist} \times {s}_{hist} ( {t}_{p} , {t}_{c} )$$

In one embodiment, to make scores more interpretable, consider a variation of the TF-IDF formulation that “counts column matches”:

$${tf}_{i} ( c , t ) = {max}_{{c}^{′} ∈ t} {s}_{i} ( c , {c}^{′} )$$

$${n}_{i} ( c , T ) = \vert \{ t ∈ T s . t . {tf}_{i} ( c , t ) > L \} \vert$$

$${idf}_{i} ( c , T ) = {idf}_{i} ( c , T ) = \frac{\text{?}}{max ( {n}_{i} ( c , T ) , 1 )} “ Linear IDF ” ( default )$$

$${idf}_{i} ( c , T ) = \frac{1}{max ( {n}_{i} ( c , T ) , 1 ) \text{?}} 1 / 2 ) “ Power IDF ” with parameter$$

$${idf}_{i} ( c , T ) = \frac{1}{{log}_{i} ( max ( {a}_{i} ( c , T ) , 1 ) )} + 1 ← “ Log IDF ” with \\ parameter ( default 2 )$$

$${Idf}_{i} ( c , T ) ← “ No IDF ”$$

$$s ( {t}_{p} , {t}_{c} ) = {\sum }_{c ∈ {t}_{p}} {max}_{i} \{ {tf}_{i} ( c , {t}_{c} ) \times {idf}_{i} ( c , C ) \} ← Note the update to max ( )$$

$$\overline{s} ( {t}_{p} , {t}_{c} ) = agg ( s ( {t}_{p} , {t}_{c} ) , s ( {t}_{c} , {t}_{p} ) ) ← max ( ) or \\ average ( ) can be parameterized .$$

$$\text{?} \text{indicates text missing or illegible when filed}$$

The choice to use a one-way or two-way similarity score function can be configurable for determining table lineages from the similarity scores. Once table similarity scores (434) s (tₚ, t_{c}) are computing for (most) producer and consumer tables. The output of the maximum consumer table can be simplified for each producer table subject to a relative to some lower-bound on the scores to be determined. A modular computation computes the sparse pairwise similarity matrix for each factor such as data, header, hist, and the like. For each sparse similarity matrix, compute a sparse pairwise table similarity matrix using the TF-IDF formulation. Perform a weighted sum of the sparse matrices to arrive at the final sparse pairwise similarity matrix.

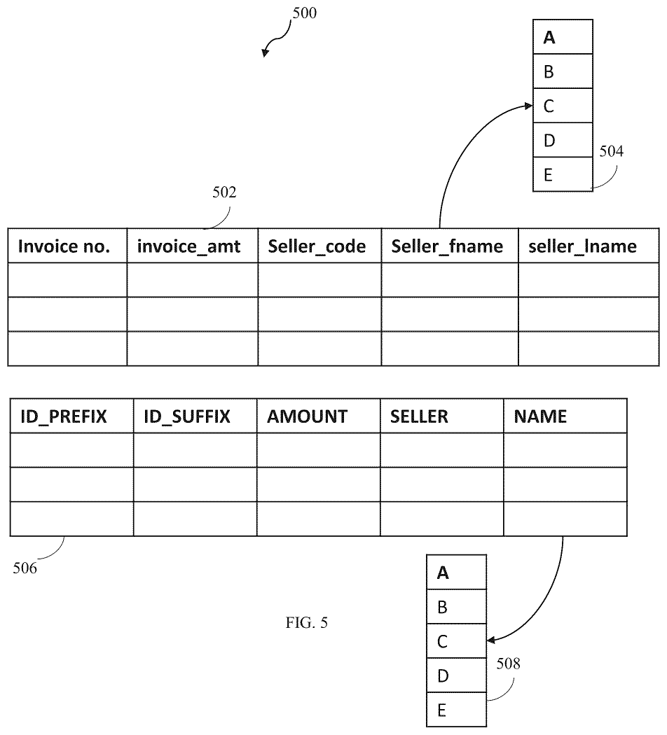

FIG. 5 is a schematic representation of an exemplary embodiment of the representation of data transformation of FIG. 1 in accordance with an embodiment of the present disclosure. In one embodiment, an inferred lineage via similar descriptors under data transforms is illustrated. In one embodiment, at a high level, the histogram-based similarity of two columns is calculated by mapping the entries to counting integers by sorting on the relative frequency if a column of a table is not of numeric type. For example, if there is a column 504 of a table 502 of first names and “A” is the most common name the system maps “A” to 1, the next most common name to 2, and so on. This mapping is performed with column 508 of table 2 506 Also, for calculation, after mapping build a histogram for each column. Calculate the score using the Jensen-Shannon divergence between the two histograms. At a high level, AI embedding similarity is computed by computing embedding for each column and computing similarities among them. This can be done using any number of metrics, including Euclidean Distance, Dot Product, Cosine Similarity, and the like. The algorithm is that can be applied to variants of columns, not just the original columns, and so it is compatible with the framework described for matched content that computes lineages under data transformations.

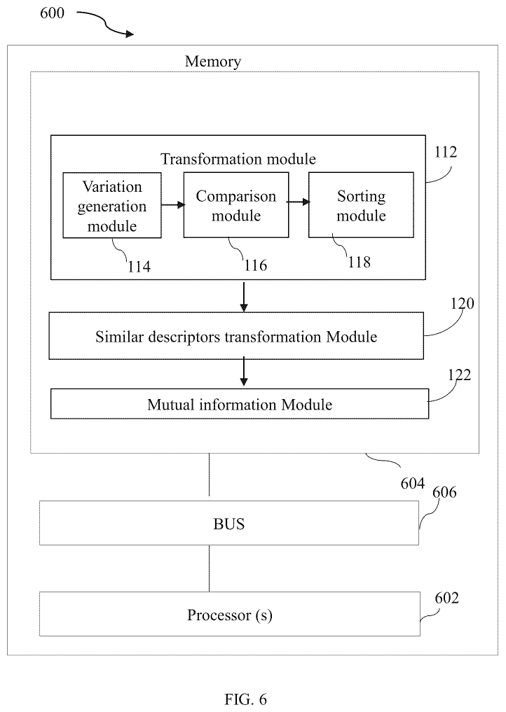

FIG. 6 is a block diagram of a computer or a server 600 in accordance with an embodiment of the present disclosure. The server 600 includes a processor(s) 602, and memory 604 is operatively coupled to the bus 606. The processor(s) 602, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 604 includes several subsystems stored in the form of a computer-readable medium which instructs the processor to perform the method steps illustrated in FIG. 1. The memory 604 is substantially similar to system 100 of FIG. 1. The memory 604 has the following subsystems: a transformation module 112, a similar descriptors transformation 120, and a mutual information module 122. The transformation module 112 includes a variation generation module 114, a comparison module 116, and a sorting module 118.

The variation generation module 114 is configured to generate a plurality of variants by applying a plurality of transformations to each column of a plurality of source tables and corresponding target tables.

The comparison module 116 is operatively coupled with the variation generation module 114. The comparison module 116 is configured to use one or more column-similarity functions to compute a table similarity and compute an inverse document frequency term in a distributed manner. The comparison module 116 is also configured to compute a term frequency in a distributed manner to determine a table lineage from a plurality of similarity scores. Further, the comparison module 116 is configured to compute a sparse pairwise similarity matrix for each factor of a plurality of factors of a column by formulating the term frequency and the inverse document frequency term. Furthermore, the comparison module 116 is configured to compute the sparse pairwise similarity matrix for each factor and a weighted sum of computed sparse pairwise similarity metrics to obtain a final sparse pairwise similarity matrix.

The sorting module 118 is operatively coupled with the comparison module 116. The sorting module 118 is configured to sort the columns of the source table in descending order based on entries covered in a destination table and based on a column of the source table. The sorting module 118 is also configured to revise a plurality of estimates covered by the destination table. The revision is based on collection of tables to provide more weight to columns of source table based on destination table. Further, the sorting module 118 is configured to prune the column of the source table for a low revised estimates of coverage and remove remaining corresponding column lineages to maintain similarities among the columns that have a table lineage.

The similar descriptors transformation module 120 is operatively coupled with the transformation module. The similar descriptors transformation module 120 is configured to calculate a histogram-based similarity of two columns and variants of columns if the column is non-numeric type. The similar descriptors transformation module 120 is also configured to map a plurality of entries of the columns to count integers by sorting relative frequency and build a histogram for each column. Further, the similar descriptors transformation module 120 is configured to calculate a score between the two histograms using a Jensen Shannon divergence method, compute an artificial intelligence embedding by calculating an embedding for each column, variants of columns, and computing similarities among the variants of columns by using a number of metrics. In one embodiment, the artificial intelligence embedding typically refers to the process of representing data in a lower-dimensional space. This process is commonly used in machine learning tasks, particularly in natural language processing (NLP).

The mutual information module 122 is operatively coupled with the similar descriptors transformation module. The mutual information module 122 is configured to build a supervised regression model to be fitted with a numerical source column as an input data and a numerical target column and record a loss value. The similar descriptors transformation module 120 is also configured to rank importance of each feature corresponding to each numerical source column based on the score after fitting the supervised regression model. Further, the similar descriptors transformation module 120 is configured to iteratively remove one feature from the numerical source columns and re-fit the supervised regression model with new numerical source columns and the numerical target column by removing one feature and record a loss value. Furthermore, the similar descriptors transformation module 120 is configured to stop the iterative removal of the feature at an occurrence a jump in loss value and generate a target column by using remaining features as top source columns. The remaining features are the features remained after stopping the iterative removal of the feature.

The bus 606 as used herein refers to be the internal memory channels or computer network that is used to connect computer components and transfer data between them. The bus 606 includes a serial bus or a parallel bus, wherein the serial bus transmits data in bit-serial format and the parallel bus transmits data across multiple wires. The bus 606 as used herein may include but not limited to, a system bus, an internal bus, an external bus, an expansion bus, a frontside bus, a backside bus, and the like.

While computer-readable medium is shown in an example embodiment to be a single medium, the term “computer-readable medium” should be taken to include a single medium or multiple media (for example, a centralized or distributed database, or associated caches and servers) able to store the instructions. The term “computer-readable-medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 602.

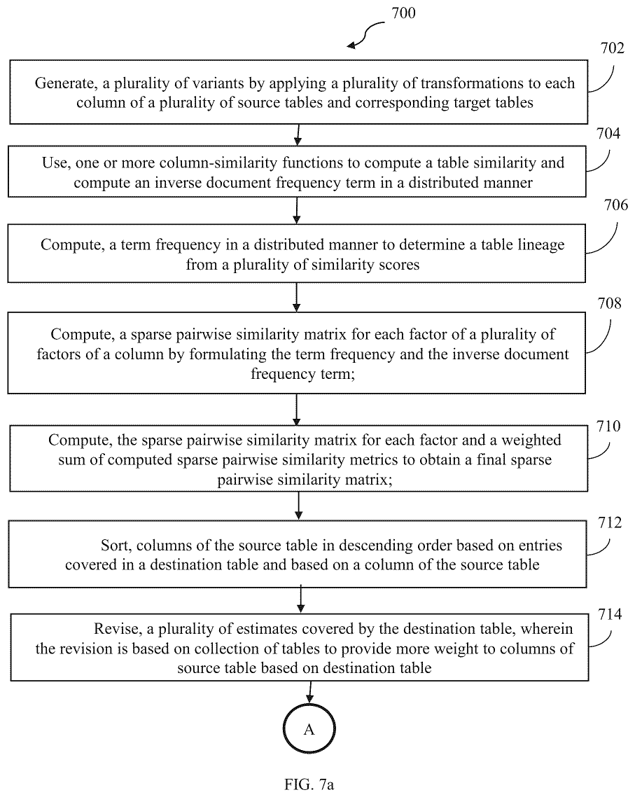

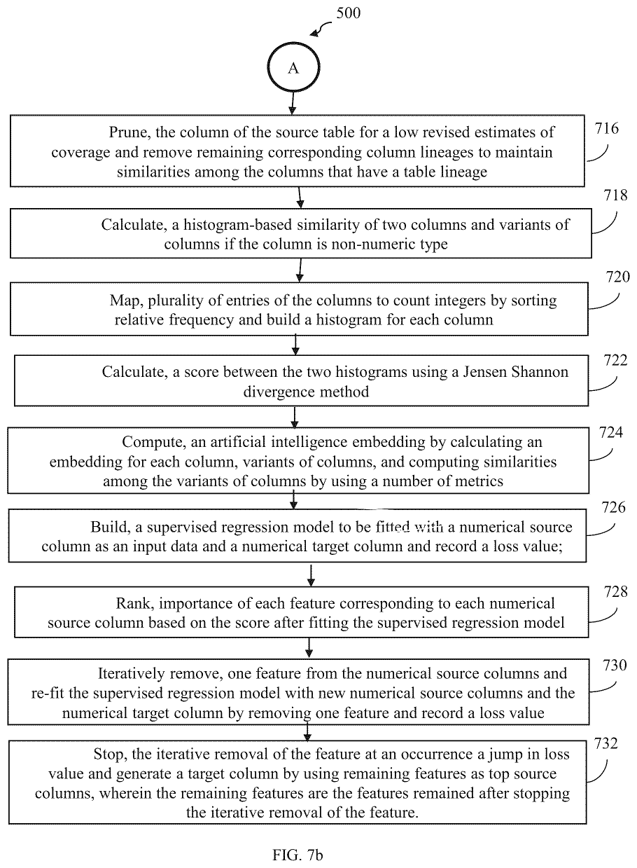

FIG. 7 (a) illustrates a flow chart representing the steps involved in a method 500 for operating a computer implemented system for inferred lineage in data transformations in accordance with an embodiment of the present disclosure and FIG. 7 (b) illustrates continued steps of the method 500 of FIG. 7 (a) in accordance with an embodiment of the present disclosure.

The method 700 starts at step 702.

At step 702, a variation generation module of a transformation module of a processing subsystem, generates a plurality of variants by applying a plurality of transformations to each column of a plurality of source tables and corresponding target tables.

At step 704, a comparison module of the transformation module of a processing subsystem, uses one or more column-similarity functions to compute a table similarity and compute an inverse document frequency term in a distributed manner.

At step 706, the comparison module of the transformation module of a processing subsystem, computes a term frequency in a distributed manner to determine a table lineage from a plurality of similarity scores.

At step 708, the comparison module of the transformation module of a processing subsystem, computes a sparse pairwise similarity matrix for each factor of a plurality of factors of a column by formulating the term frequency and the inverse document frequency term.

At step 710, the comparison module of the transformation module of a processing subsystem, compute the sparse pairwise similarity matrix for each factor and a weighted sum of computed sparse pairwise similarity metrics to obtain a final sparse pairwise similarity matrix.

At step 712, a sorting module of the transformation module of the processing subsystem, sort columns of the source table in descending order based on entries covered in a destination table and based on a column of the source table.

At step 714, the sorting module of the transformation module of the processing subsystem, revise a plurality of estimates covered by the destination table, wherein the revision is based on collection of tables to provide more weight to columns of source table based on destination table;

At step 716, the sorting module of the transformation module of the processing subsystem, prunes the column of the source table for a low revised estimates of coverage and remove remaining corresponding column lineages to maintain similarities among the columns that have a table lineage.

At step 718, a similar descriptors transformation module of the processing subsystem, calculates a histogram-based similarity of two columns and variants of columns if the column is non-numeric type.

A step 720, the similar descriptors transformation module of the processing subsystem, maps a plurality of entries of the columns to count integers by sorting relative frequency and build a histogram for each column.

At step 722, the similar descriptors transformation module of the processing subsystem, calculates a score between the two histograms using a Jensen Shannon divergence method. The method 700 also includes extending, a prior algorithm to use a plurality of descriptors of the data in a column. The method 700 also includes providing, a plurality of type of inferred lineage comprising at least one of a matched content, a similar descriptor, and a mutual information.

At step 724, the similar descriptors transformation module of the processing subsystem, computes an artificial intelligence embedding by calculating an embedding for each column, variants of columns, and computing similarities among the variants of columns by using a number of metrics. The method 700 also includes computing, artificial intelligence embedded similarity by computing embedding for each column and computing similarities among them via a plurality of metrics.

At step 726, a mutual information module of the processing subsystem, builds a supervised regression model to be fitted with a numerical source column as an input data and a numerical target column and record a loss value.

At step 728, the mutual information module of the processing subsystem, ranks the importance of each feature corresponding to each numerical source column based on the score after fitting the supervised regression model.

At step 730, the mutual information module of the processing subsystem, iteratively removes one feature from the numerical source columns and re-fit the supervised regression model with new numerical source columns and the numerical target column by removing one feature and record a loss value. The method 700 also includes providing, an inferred lineage via matched content.

At step 732, the mutual information module of the processing subsystem, stops the iterative removal of the feature at an occurrence a jump in loss value and generate a target column by using remaining features as top source columns, wherein the remaining features are the features remained after stopping the iterative removal of the feature. The method 700 also includes starting, iterative removal of one feature from the numerical source columns.

Various embodiments of the present disclosure provides a computer implemented system for inferred lineage in data transformations. The system disclosed in the present disclosure determines which source table led to which target table. The sorting module of the system disclosed in the present disclosure removes characters and text from a cell according to a user-supplied regular expression. The sorting module and the mutual information module of the system disclosed in the present disclosure removes all whitespace from a cell. The transformation module of the system disclosed in the present disclosure effectively mix a data across tables.

Further, the mutual information module of the system disclosed in the present disclosure is able to stop the iterative removal of the feature at an occurrence a jump in loss value and generate a target column by using remaining features as top source columns. After stopping the remaining features are the features remained after stopping the iterative removal of the feature.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A computer-implemented system for inferred lineage in data transformations comprising:
a hardware processor;
a memory operatively coupled to the hardware processor wherein the memory comprises a set of instructions in the form of a processing subsystem, configured to be executed by the hardware processor, wherein the processing subsystem is hosted on a server, and configured to execute on a network to control bidirectional communications among a plurality of modules wherein the plurality of modules comprises:
a transformation module comprising:
a variation generation module configured to generate a plurality of variants by applying a plurality of transformations to each column of a plurality of source tables and corresponding target tables;
a comparison module operatively coupled with the variation generation module, wherein the comparison module is configured to:
use one or more column-similarity functions to compute a table similarity and compute an inverse document frequency term in a distributed manner;
compute a term frequency in a distributed manner to determine a table lineage from a plurality of similarity scores;
compute a sparse pairwise similarity matrix for each factor of a plurality of factors of a column by formulating the term frequency and the inverse document frequency term; and
compute the sparse pairwise similarity matrix for each factor and a weighted sum of computed sparse pairwise similarity metrics to obtain a final sparse pairwise similarity matrix;
a sorting module operatively coupled with the comparison module, wherein the sorting module is configured to:
sort the columns of the source table in descending order based on entries covered in a destination table and based on a column of the source table;
revise a plurality of estimates covered by the destination table, wherein the revision is based on collection of tables to provide more weight to columns of source table based on destination table; and
prune the column of the source table for a low revised estimates of coverage and remove remaining corresponding column lineages to maintain similarities among the columns that have a table lineage;
a similar descriptors transformation module operatively coupled with the transformation module, wherein the similar descriptors transformation module is configured to:
calculate a histogram-based similarity of two columns and variants of columns if the column is non-numeric type;
map a plurality of entries of the columns to count integers by sorting relative frequency and build a histogram for each column;
calculate a score between the two histograms using a Jensen Shannon divergence method; and
compute an artificial intelligence embedding by calculating an embedding for each column, variants of columns, and computing similarities among the variants of columns by using a number of metrics;
a mutual information module operatively coupled with the similar descriptors transformation module, wherein the mutual information module is configured to:
build a supervised regression model to be fitted with a numerical source column as an input data and a numerical target column and record a loss value;
rank importance of each feature corresponding to each numerical source column based on the score after fitting the supervised regression model;
iteratively remove one feature from the numerical source columns and re-fit the supervised regression model with new numerical source columns and the numerical target column by removing one feature and record a loss value; and
stop the iterative removal of the feature at an occurrence a jump in loss value and generate a target column by using remaining features as top source columns, wherein the remaining features are the features remained after stopping the iterative removal of the feature.

2. The computer-implemented system as claimed in claim 1, wherein the plurality of transformations comprises at least one of a lowercase, no transformations, a regex remover for removing characters from a cell according to a user-supplied regular expression, a split and take, truncate, whitespace cleaner, condition to apply a transformation based on a condition, composite comprising a chain of the previous transformations in a sequence.

3. The computer-implemented system as claimed in claim 2, wherein the split and take transformation comprises splitting of text according to a user-supplied regular expression and taking a specific index from the split.

4. The computer-implemented system as claimed in claim 2, wherein the no transformation is applied if a variant generator is un-specified.

5. The computer-implemented system as claimed in claim 1, wherein the comparison module is configured to compute a min-hash similarity of each pair of column-variations subject to a lower bound based on similarity.

6. The computer-implemented system as claimed in claim 1, wherein the comparison module is configured to aggregate the column-variation similarities to compute the column-level similarities.

7. The computer-implemented system as claimed in claim 1, wherein the comparison module is configured to compute term frequency-inverse document frequency to obtain the table similarity.

8. The computer-implemented system as claimed in claim 1, wherein the transformation module is configured to remove unlikely column lineage content.

9. The computer-implemented system as claimed in claim 1, wherein the plurality of metrics comprises at least one of an Euclidean distance, a dot product, and a cosine similarity.

10. A method for operating computer-implemented system for inferred lineage in data transformations comprising:
generating, by a variation generation module of a transformation module of a processing subsystem, a plurality of variants by applying a plurality of transformations to each column of a plurality of source tables and corresponding target tables;
using, by a comparison module of the transformation module of a processing subsystem, one or more column-similarity functions to compute a table similarity and compute an inverse document frequency term in a distributed manner;
computing, by the comparison module of the transformation module of a processing subsystem, a term frequency in a distributed manner to determine a table lineage from a plurality of similarity scores;
computing, by the comparison module of the transformation module of a processing subsystem, a sparse pairwise similarity matrix for each factor of a plurality of factors of a column by formulating the term frequency and the inverse document frequency term;
computing, by the comparison module of the transformation module of a processing subsystem, the sparse pairwise similarity matrix for each factor and a weighted sum of computed sparse pairwise similarity metrics to obtain a final sparse pairwise similarity matrix;
sorting, by a sorting module of the transformation module of the processing subsystem, columns of the source table in descending order based on entries covered in a destination table and based on a column of the source table;
revising, by the sorting module of the transformation module of the processing subsystem, a plurality of estimates covered by the destination table, wherein the revision is based on collection of tables to provide more weight to columns of source table based on destination table;
pruning, by the sorting module of the transformation module of the processing subsystem, the column of the source table for a low revised estimates of coverage and remove remaining corresponding column lineages to maintain similarities among the columns that have a table lineage;
calculating, by a similar descriptors transformation module of the processing subsystem, a histogram-based similarity of two columns and variants of columns if the column is non-numeric type;
mapping, by the similar descriptors transformation module of the processing subsystem, a plurality of entries of the columns to count integers by sorting relative frequency and build a histogram for each column;
calculating, by the similar descriptors transformation module of the processing subsystem, a score between the two histograms using a Jensen Shannon divergence method;
computing, by the similar descriptors transformation module of the processing subsystem, an artificial intelligence embedding by calculating an embedding for each column, variants of columns, and computing similarities among the variants of columns by using a number of metrics;
building, by a mutual information module of the processing subsystem, a supervised regression model to be fitted with a numerical source column as an input data and a numerical target column and record a loss value;
ranking, by the mutual information module of the processing subsystem, importance of each feature corresponding to each numerical source column based on the score after fitting the supervised regression model;
iteratively removing, by the mutual information module of the processing subsystem, one feature from the numerical source columns and re-fit the supervised regression model with new numerical source columns and the numerical target column by removing one feature and record a loss value; and
stopping, by the mutual information module of the processing subsystem, the iterative removal of the feature at an occurrence a jump in loss value and generate a target column by using remaining features as top source columns, wherein the remaining features are the features remained after stopping the iterative removal of the feature.

11. The method as claimed in claim 10, comprises starting, iterative removal of one feature from the numerical source columns.

12. The method as claimed in claim 10, comprises providing, an inferred lineage via matched content.

13. The method as claimed in claim 10, comprises extending, a prior algorithm to use a plurality of descriptors of the data in a column.

14. The method as claimed in claim 10, comprises providing, a plurality of type of inferred lineage comprising at least one of a matched content, a similar descriptor, and a mutual information.

15. The method as claimed in claim 10, comprises computing, artificial intelligence embedded similarity by computing embedding for each column and computing similarities among them via a plurality of metrics.

16. A non-transitory computer-readable medium storing a computer program that, when executed by a processor, causes the processor to perform method operating computer-implemented system for inferred lineage wherein the method comprises:
generating, by variation generation module of a transformation module of a processing subsystem, a plurality of variants by applying a plurality of transformations to each column of a plurality of source tables and corresponding target tables;
using, by a comparison module of the transformation module of a processing subsystem, one or more column-similarity functions to compute a table similarity and compute an inverse document frequency term in a distributed manner;
computing, by the comparison module of the transformation module of a processing subsystem, a term frequency in a distributed manner to determine a table lineage from a plurality of similarity scores;
computing, by the comparison module of the transformation module of a processing subsystem a sparse pairwise similarity matrix for each factor of a plurality of factors of a column by formulating the term frequency and the inverse document frequency term;
computing, by the comparison module of the transformation module of a processing subsystem, the sparse pairwise similarity matrix for each factor and a weighted sum of computed sparse pairwise similarity metrics to obtain a final sparse pairwise similarity matrix;
sorting, by a sorting module of the transformation module of the processing subsystem, columns of the source table in descending order based on entries covered in a destination table and based on a column of the source table;
revising, by the sorting module of the transformation module of the processing subsystem, a plurality of estimates covered by the destination table, wherein the revision is based on collection of tables to provide more weight to columns of source table based on destination table;
pruning, by the sorting module of the transformation module of the processing subsystem, the column of the source table for a low revised estimates of coverage and remove remaining corresponding column lineages to maintain similarities among the columns that have a table lineage;
calculating, by a similar descriptors transformation module of the processing subsystem, a histogram-based similarity of two columns and variants of columns if the column is non-numeric type;
mapping, by the similar descriptors transformation module of the processing subsystem, a plurality of entries of the columns to count integers by sorting relative frequency and build a histogram for each column;
calculating, by the similar descriptors transformation module of the processing subsystem, a score between the two histograms using a Jensen Shannon divergence method;
computing, by the similar descriptors transformation module of the processing subsystem, an artificial intelligence embedding by calculating an embedding for each column, variants of columns, and computing similarities among the variants of columns by using a number of metrics;
building, by a mutual information module of the processing subsystem, a supervised regression model to be fitted with a numerical source column as an input data and a numerical target column and record a loss value;
ranking, by the mutual information module of the processing subsystem, importance of each feature corresponding to each numerical source column based on the score after fitting the supervised regression model;
iteratively removing, by the mutual information module of the processing subsystem, one feature from the numerical source columns and re-fit the supervised regression model with new numerical source columns and the numerical target column by removing one feature and record a loss value; and
stopping, by the mutual information module of the processing subsystem, the iterative removal of the feature at an occurrence a jump in loss value and generate a target column by using remaining features as top source columns, wherein the remaining features are the features remained after stopping the iterative removal of the feature.
